(19) United States
(12) Patent Application Publication
(10) Pub. No.: US 2011/0163823 A1
(43) Pub. Date: Jul. 7, 2011

(54) ELECTROMAGNETIC BANDGAP STRUCTURE AND CIRCUIT BOARD

(75) Inventors: Dae-Hyun PARK, Joong-gu (KR); Han Kim, Yongin-si (KR); Myung-Sam Kang, Hwasung-si (KR)

(73) Assignee: SAMSUNG ELECTRO-MECHANICS CO., LTD.

(21) Appl. No.: 12/983,073

(22) Filed: Dec. 31, 2010

(30) Foreign Application Priority Data
Jan. 4, 2010 (KR) 10-2010-0000088

(51) Int. Cl. H04B 3/28

(52) U.S. Cl. 333/12; 333/185

(57) ABSTRACT

In an electromagnetic bandgap structure including a plurality of conductive plates and a stitching via part, in which the plurality of conductive plates are placed on a first planar surface, the stitching via part includes a first via having one end part connected to one of the two conductive plates, a second via having one end part connected to the other of the two conductive plates, a spiral connector forming a spirally-shaped serial link structure on at least one vertical planar surface that is perpendicular to the first planar surface, a first conductive pattern connecting one end part of the spiral connector and the other end part of the first via with each other and a second conductive connecting pattern connecting the other end part of the spiral connector and the other end part of the second via with each other.

### CROSS-REFERENCE TO RELATED APPLICATIONS

This application claims the benefit of Korean Patent Application No. 10-2010-0000088, filed with the Korean Intellectual Property Office on Jan. 4, 2010, the disclosure of which is incorporated herein by reference in its entirety.

### BACKGROUND

1. Technical Field

The present invention is related to an electromagnetic bandgap structure, more specifically to an electromagnetic bandgap structure and a printed circuit board having the same that prevent a signal ranging a certain frequency band from being transferred.

2. Description of the Related Art

New electronic apparatuses and communication apparatuses are increasingly becoming smaller, thinner and lighter, reflecting today's emphasis on growing mobility.

These electronic and communication apparatuses have various complex electronic circuits (i.e. analog circuits and digital circuits) for performing their functions and operations. These electronic circuits typically carry out their functions by being implemented in a printed circuit board (PCB). The electronic circuits on the PCB commonly have different operation frequencies from one another.

The printed circuit board in which various electronic circuit boards are implemented often has a noise problem, caused by the transfer of an electromagnetic (EM) wave resulted from the operation frequency and its corresponding harmonics components of one electronic circuit to another electronic circuit. The transferred noise can be roughly classified into radiation noise and conduction noise.

The radiation noise (refer to the reference numeral 155 of FIG. 1) can be easily prevented by covering a protective cap on the electronic circuit. However, preventing the conduction noise (refer to the reference numeral 150 of FIG. 1) is not as easy, because the conduction noise is transferred through a signal transfer path inside the board.

The noise problem will be described in more detail with reference to FIG. 1. FIG. 1 is a sectional view showing a printed circuit board including two electronic circuits having different operation frequencies. Although FIG. 1 shows a 4-layered printed circuit board 100, it shall be evident that the printed circuit board can be modified to have a 2, 6 or 8-layered structure.

As shown in FIG. 1, the printed circuit board 100 includes four metal layers 110-1, 110-2, 110-3 and 110-4 (hereinafter, collectively referred to as 110) and dielectric layers 120-1, 120-2 and 120-3 (hereinafter, collectively referred to as 120) interposed between metal layers 110. The top metal layer 110-1 of the printed circuit board 100 is implemented with two electronic circuits 130 and 140 having different operation frequencies (hereinafter, referred to as a first electronic circuit 130 and a second electronic circuit 140, respectively). Here, it is assumed that the two electronic circuits 130 and 140 are digital circuits.

Here, if it is assumed that the metal layer represented by the reference numeral 110-2 is a ground layer and the metal layer represented by the reference numeral 110-3 is a power layer, each ground pin of the first electronic circuit 130 and the second electronic circuit 140 is electrically connected to the metal layer represented by the reference numeral 110-2 and each power pin is electrically connected to the metal layer represented by the reference numeral 110-3. In the printed circuit board 100, every ground layer is also electrically connected to one another through vias. Similarly, every power layer is also electrically connected to one another through vias. As an example, a via 160 electrically connects the metal layers of the reference numerals 110-1, 110-3, and 110-4 as shown in FIG. 1.

At this time, if the first electronic circuit 130 and the second electronic circuit 140 have different operation frequencies, a conductive noise 150 caused by an operation frequency of the first electronic circuit 130 and its harmonics components is transferred to the second electronic circuit 140. This has a disadvantageous effect on the accurate function/operation of the second electronic circuit 140.

With the growing complexity of electronic apparatuses and higher operation frequencies of digital circuits, it is increasingly difficult to solve this conduction noise problem. Especially, the typical bypass capacitor method or decoupling capacitor method for solving the conductive noise problem is no longer adequate, as the electronic apparatuses use a higher frequency band.

Moreover, the aforementioned solutions are not adequate when several active devices and passive devices need to be implemented in a complex wiring board having various types of electronic circuits formed on the same board or in a narrow area such as a system in package (SiP) or when a high frequency band is required for the operation frequency, as in a network board.

Accordingly, an electromagnetic bandgap structure (EBG) is recently receiving attention as a scheme to solve the aforementioned conductive noise. This is for the purpose of blocking a signal ranging a certain frequency band by arranging the EBG having a certain structure in a printed circuit board, and the typical EBG has roughly two, namely a Mushroom type EBG(MT-EBG) and a Planar type EBG(PT-EBG).

A general form of the MT-EBG is illustrated in FIG. 2.

For example, the MT-EBG has the structure in which a plurality of EBG cells (refer to the reference numeral 230 of FIG. 2) having a mushroom form are interposed between two metal layers which function as a power layer and a ground layer. FIG. 2 shows only four EBG cells for the convenience of illustration.

With reference to FIG. 2, the MT-EBG 200 further forms a metal plate 231 between a first metal layer 210 and a second metal layer 220 that function as one of the ground layer and the power layer and the other of the ground layer and the power layer, respectively, and has a form in which the mushroom type structures 230 connecting the first metal layer 210 and the metal plate 231 through a via 232 are repeatedly arranged. At this time, a first dielectric layer 215 is interposed between the first metal layer 210 and the metal plate 231, and a second dielectric layer 225 is interposed between the metal plate 231 and the second metal layer 220.

Such MT-EBG 200 performs the function of a sort of band stop filter, by having the state in which a capacitance component formed by the second metal layer 220, the second dielectric layer 225 and the metal plate 231, and an inductance component formed by the via 232 penetrating the first dielectric layer 215 and connecting the first metal layer 210 with the metal plate 231 are connected in L-C series between the first metal layer 210 and the second layer 220.

However, the largest demerit of this structure is the increase of layers, because it needs at least 3 layers to implement the MT-EBG 200. In this case, not only does the manufacturing cost of the PCB increase, but also the design freedom is limited.

The PT-EBG is illustrated in FIG. 3.

The PT-EBG has a structure in which a plurality of EBG cells (refer to the reference numeral 320-1 of FIG. 3) having a certain pattern are repeatedly arranged through any entire metal layer that functions as one of the ground layer and the power layer. FIG. 3 also shows only four EBG cells for the convenience of illustration.

With reference to FIG. 3, the PT-EBG 300 has a form in which a metal layer 310 and a plurality of metal plates 321-1, 321-2, 321-3 and 321-4 which are placed on another planar surface are bridged to one another through a certain part of metal plates (the edge end of each metal plate in FIG. 3) by metal branches 322-1, 322-2, 322-3 and 322-4.

At this time, the metal plates 321-1, 321-2, 321-3 and 321-4 having a large size constitute the low impedance area and the metal branches having a small size constitute the high impedance area. Accordingly, the PT-EBG performs the function of a band stop filter that can block a noise ranging a certain frequency band through the structure in which the low impedance area and the high impedance area are alternately repeated.

Although such PT-EBG structure has a merit of forming the bandgap structure by using two layers only in contrast to the structure of MT-EBG there is not only a difficulty in making cells smaller but also a design limit, which makes it hard to apply the PT-EBG to various application products because it is formed in a lager area. This is because the PT-EBG forms the EBG structure by not utilizing various parameters but using only two impedance components.

As described above, the EBG structures according to the conventional technology, such as the MT-EBG and the PT-EBG, have a limit in adjusting each bandgap frequency band that is appropriate to the conditions and features required for various application products or lowering a conductive noise below the intended noise level within a pertinent bandgap frequency band.

Accordingly, studies for an EBG structure that can not only solve the aforementioned conductive noise problem but also be universally applied to various application products, for which the required bandgap frequency bands differ, are desperately needed.

### SUMMARY

Accordingly, the present invention provides an electromagnetic bandgap structure and a printed circuit board having the same that can block a conductive noise of a certain frequency band.

The present invention also provides a printed circuit board that can solve a conductive noise problem through an electromagnetic bandgap structure having a certain structure in the printed circuit board without using a bypass capacitor or a decoupling capacitor.

In addition, the present invention provides an electromagnetic bandgap structure and a printed circuit board that have appropriate design flexibility and design freedom for the printed circuit board and that can be universally applied to various application products (for example, an electronic apparatus (e.g. a mobile communication terminal) including an RF circuit and a digital circuit which are placed in the same board, SiP (System in Package), and network board, etc.) by enabling the realization of various bandgap frequency band.

Other problems that the present invention solves will become more apparent through the following description.

An aspect of present invention features an electromagnetic bandgap structure that can block a noise of a certain frequency band.

In accordance with an embodiment of the present invention, an electromagnetic bandgap structure that includes a plurality of conductive plates and a stitching via part, in which the plurality of conductive plates are placed on a first planar surface and the stitching via part electrically connects any two conductive plates of the plurality of conductive plates with each other, is provided. Here, the stitching via part can include a first via, which has one end part connected to one of the two conductive plates, a second via, which has one end part connected to the other of the two conductive plates, a spiral connector, which forms a spirally-shaped serial link structure on at least one vertical planar surface that is perpendicular to the first planar surface, a first conductive pattern, which connects one end part of the spiral connector and the other end part of the first via with each other, and a second conductive connecting pattern, which connects the other end part of the spiral connector and the other end part of the second via with each other.

The spiral connector can form the spirally-shaped serial link structure on the at least one vertical planar surface by using a conductive connecting pattern to connect two different locations with each other on a same planar surface and using a via to connect two different planar surfaces with each other.

The at least one vertical planar surface on which the spiral connector is to be formed can be a vertical planar surface that exists in a position corresponding to a separated space between the two conductive plates, in which the two conductive plates are connected to each other by the stitching via part.

If the spiral connector is formed on two or more vertical planar surfaces, two or more spiral link structures can be formed on the two or more vertical planar surfaces, respectively, and parts placed on different vertical planar surfaces can be connected to each other by a conductive connecting pattern so that the spirally-shaped serial link structure is formed.

The spiral connector can form the spirally-shaped serial link structure by manufacturing a link structure that is bent at least once by using the at least one conductive connecting pattern and the at least one via. Here, the spirally-shaped serial link structure passes through a plurality of layers that exist on the at least one vertical planar surface, and the at least one conductive connecting pattern connects two different locations with each other on the same planar surface. The at least one via connects two different planar surfaces with each other.

A dielectric layer can be placed on an upper side or a lower side of the plurality of conductive plates, and the vias included in the stitching via part can penetrate through the dielectric layer.

If there is a conductive layer that faces the plurality of conductive plates and is placed on a second planar surface, a clearance hole can be formed in a portion of the conductive layer that corresponds to a path through which the stitching via part passes such that the stitching via part and the conductive layer can be electrically separated from each other.

The conductive connecting patterns included in the stitching via part can be manufactured as a straight-line form or a line form broken one or more times.

Another aspect of the present invention provides a printed circuit board in which an electromagnetic bandgap structure is disposed in an area of a noise transferable path between a noise source point and a noise blocking destination point of the printed circuit board. Here, the electromagnetic bandgap structure includes a plurality of conductive plates and a stitching via part, in which the plurality of conductive plates are placed on a first planar surface and the stitching via part electrically connects any two conductive plates of the plurality of conductive plates with each other.

Here, the stitching via part can include a first via, which has one end part connected to one of the two conductive plates, a second via, which has one end part connected to the other of the two conductive plates, a spiral connector, which forms a spirally-shaped serial link structure on at least one vertical planar surface that is perpendicular to the first planar surface, a first conductive pattern, which connects one end part of the spiral connector and the other end part of the first via with each other, and a second conductive connecting pattern, which connects the other end part of the spiral connector and the other end part of the second via with each other.

The spiral connector can form the spirally-shaped serial link structure on the at least one vertical planar surface by using a conductive connecting pattern to connect two different locations with each other on a same planar surface and using a via to connect two different planar surfaces with each other.

The at least one vertical planar surface on which the spiral connector is to be formed can be a vertical planar surface that exists in a position corresponding to a separated space between the two conductive plates, in which the two conductive plates are connected to each other by the stitching via part.

If the spiral connector is formed on two or more vertical planar surfaces, two or more spiral link structures can be formed on the two or more vertical planar surfaces, respectively, and parts placed on different vertical planar surfaces can be connected to each other by a conductive connecting pattern so that the spirally-shaped serial link structure is formed.

The spiral connector can form the spirally-shaped serial link structure by manufacturing a link structure that is bent at least once by using the at least one conductive connecting pattern and the at least one via. Here, the spirally-shaped serial link structure passes through a plurality of layers that exist on the at least one vertical planar surface, and the at least one conductive connecting pattern connects two different locations with each other on the same planar surface. The at least one via connects two different planar surfaces with each other.

A dielectric layer can be placed on an upper side or a lower side of the plurality of conductive plates, and the vias included in the stitching via part can penetrate through the dielectric layer.

If there is a conductive layer that faces the plurality of conductive plates and is placed on a second planar surface, a clearance hole can be formed in a portion of the conductive layer that corresponds to a path through which the stitching via part passes such that the stitching via part and the conductive layer can be electrically separated from each other.

The conductive plates can be electrically connected to one of a ground layer and a power layer, and the conductive layer can be electrically connected to the other of the ground layer and the power layer.

The conductive plates can be electrically connected to one of a ground layer and a signal layer, and the conductive layer can be electrically connected to the other of the ground layer and the signal layer.

If two electronic circuits having different operation frequencies are installed in the printed circuit board, the noise source point and the noise blocking destination point can correspond to one position and the other position, respectively, in which the two electric circuits are to be installed.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a sectional view showing a printed circuit board including two electronic circuits having different operation frequencies.

FIG. 2 is a schematic view showing an MT-EBG structure as an electromagnetic bandgap structure in accordance with a conventional art.

FIG. 3 is a schematic view showing a PT-EBG structure as another example of an electromagnetic bandgap structure in accordance with a conventional art.

FIG. 4A is a 3D perspective view showing an electromagnetic bandgap structure including a stitching via having a block principle similar to the present invention.

FIG. 4B is a schematic view showing an equivalent circuit of the electromagnetic bandgap structure shown in FIG. 4A.

FIG. 4C is a 3D perspective view showing a transformational example of the electromagnetic bandgap structure shown in FIG. 4A.

FIG. 5A is a plan view showing a configuration of an electromagnetic bandgap structure including a stitching via having a rectangular metal plate.

FIG. 5B is a plan view showing a configuration of an electromagnetic bandgap structure including a stitching via having a triangular metal plate.

FIG. 5C and FIG. 5D are plan views showing a configuration of an electromagnetic bandgap structure including a stitching via consisting of a plurality of groups having different sized metal plates.

FIG. 5E is a plan view showing a band-shaped configuration of an electromagnetic bandgap structure including a stitching via.

FIG. 6 is a 3D perspective view showing an electromagnetic bandgap structure in accordance with an embodiment of the present invention.

FIGS. 7A to 7D are detailed diagrams showing the electromagnetic bandgap structure shown in FIG. 6.

FIGS. 8A through 8C are diagrams showing an electromagnetic bandgap structure in accordance with another embodiment of the present invention.

FIGS. 9A through 9B are diagrams showing an electromagnetic bandgap structure in accordance with yet another embodiment of the present invention.

FIGS. 10 through 11B are diagrams showing an electromagnetic bandgap structure in accordance with still other embodiments of the present invention.

FIG. 12 is a graph showing a bandgap frequency property of an electromagnetic bandgap structure in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Throughout the description of the present invention, when describing a certain known related technology is determined to evade the point of the present invention, the pertinent detailed description will be omitted. Terms such as “first” and “second” are used only to distinguish one element from the other.

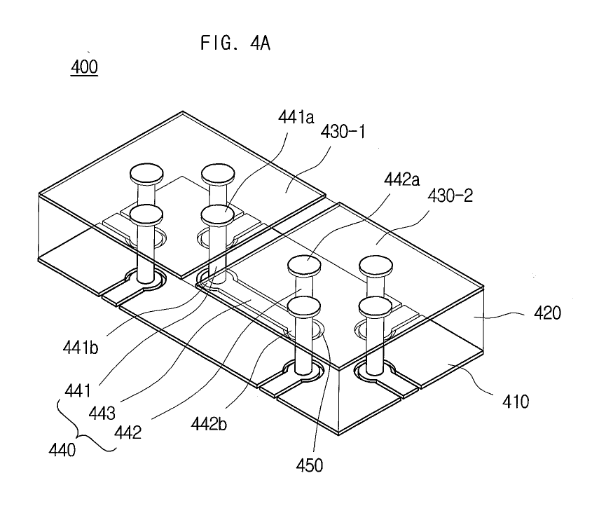

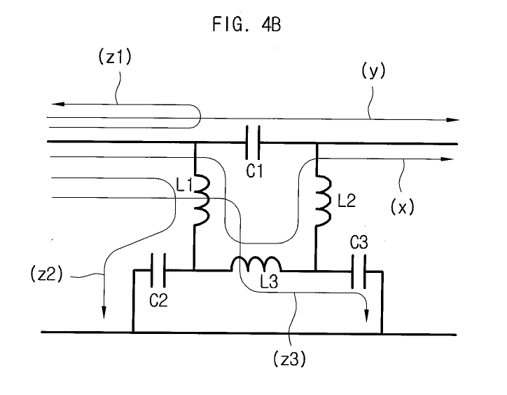

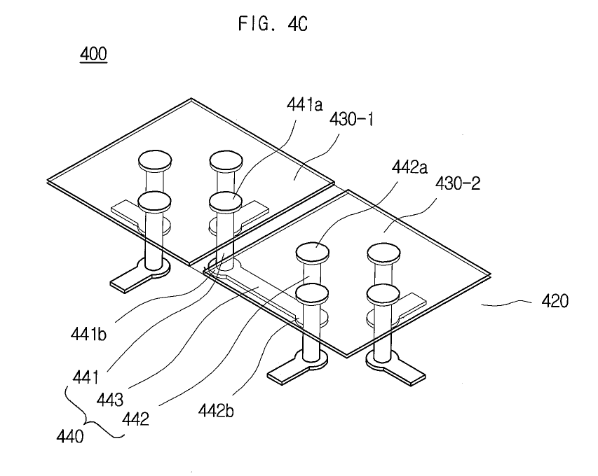

Hereinafter, some examples of an electromagnetic bandgap structure including a stitching via having a basic principle similar to a blocking noise principle in accordance with some embodiments of the present invention will be described with reference to FIG. 4A through FIG. 4C for easy understanding of the present invention before an electromagnetic bandgap structure and a printed circuit board having the same are described.

Although a metal layer, a metal plate and a metal trace/line are used throughout the description of an electromagnetic bandgap structure of the present invention, it shall be evidently understood by any person of ordinary skill in the art that any other conductive layers, conductive plates and conductive traces/lines or conductive connecting patterns can be substituted for the metal layer, the metal plate and the metal trace/line.

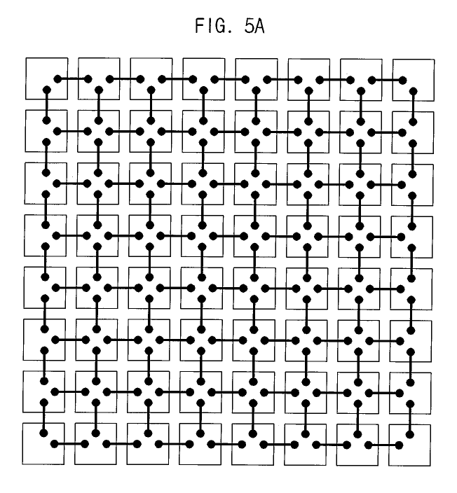

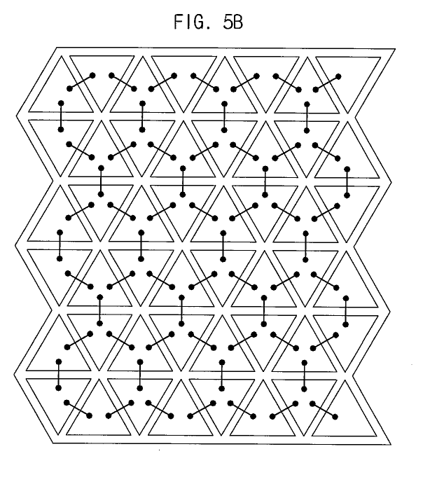

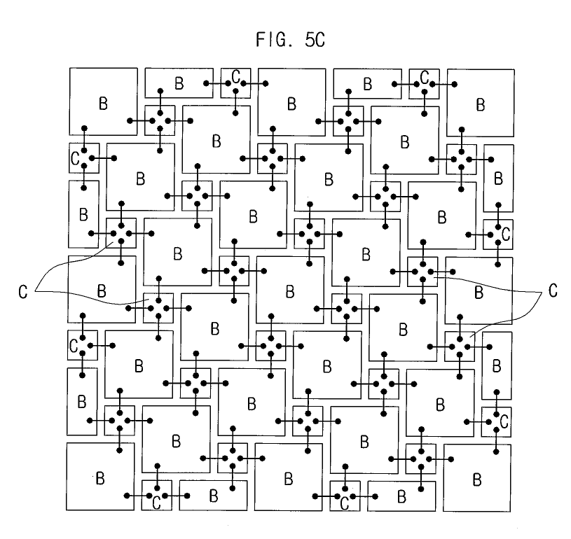

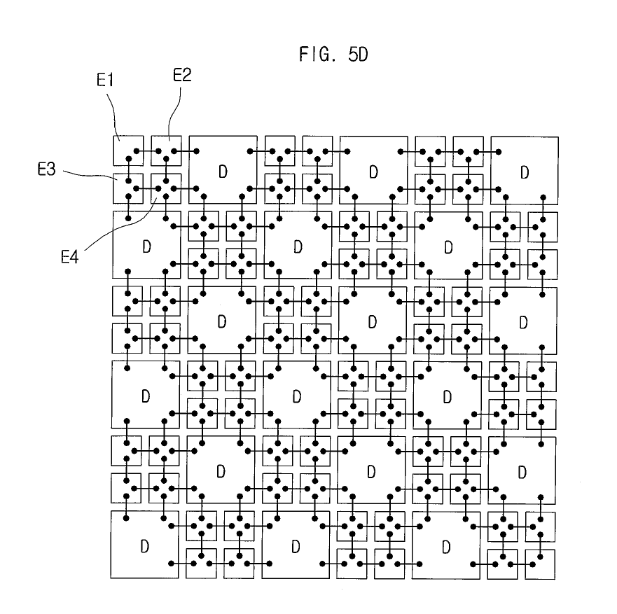

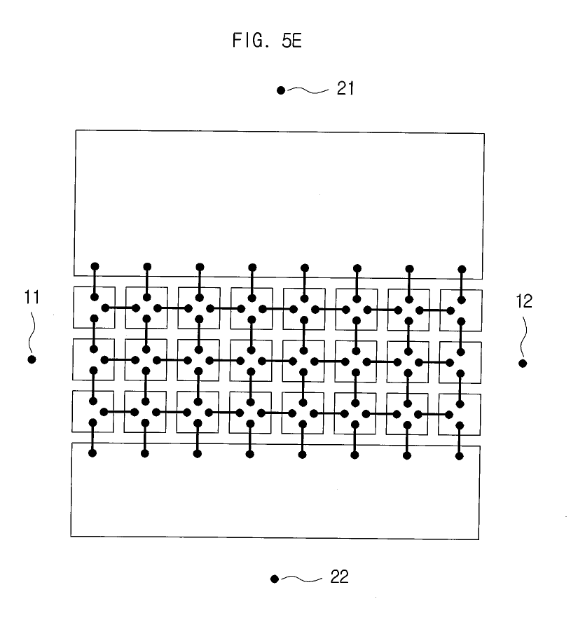

Also, even though FIG. 4A and FIG. 4C show only two metal plates for the convenience of illustration, the electromagnetic bandgap structure can have a plurality of metal plates repeatedly arranged in between noise transferable paths in the printed circuit board, as shown in FIG. 5A through FIG. 5E.

An electromagnetic bandgap structure 400 shown in FIG. 4A can include a metal layer 410, a plurality of metal plates 430-1 and 430-2 (hereinafter, referred to as a first metal plate 430-1 and a second metal plate 430-2) spaced apart from the metal layer 410 and a stitching via 440. The electromagnetic bandgap structure 400 of FIG. 4A can have a 2-layered planar structure including a first layer that can consist of the metal layer 410 and a second layer that can consist of the plurality of metal plates 430-1 and 430-2. A dielectric layer 420 can be interposed between the metal layer 410 and the plurality of metal plates 430-1 and 430-2.

Here, FIG. 4A shows elements constituting the electromagnetic bandgap structure only (i.e. the only part constituting the 2-layered electromagnetic bandgap including the stitching via) for the convenience of illustration. Accordingly, the metal layer 410 and the plurality of metal plates 430-1 and 430-2 shown in FIG. 4A may be any two layers of a multi-layered printed circuit board. In other words, it shall be evident that there can be at least one additional metal layer below the metal layer 410, above the metal plates 430-1 and 430-2 and/or between the metal layer 410 and the metal plates 430-1 and 430-2.

In addition, the electromagnetic bandgap structure 400 shown in FIG. 4A (the same can be applied to the electromagnetic bandgap structure of the present invention) can be placed between any two metal layers respectively constituting the power layer and the ground layer in order to block a conductive noise. Since the conductive noise problem is not limited to the space between the power layer and the ground layer, the electromagnetic bandgap structure shown in FIG. 4A can be placed between any two ground layers or power layers placed on different layers from each other in a multi-layered printed circuit board.

Accordingly, the metal layer 410 shown in FIG. 4A can be any one metal layer for transferring an electric signal in a printed circuit board. For example, the metal layer 410 can be any metal layer functioning as the power layer or the ground layer, or any metal layer functioning as a signal layer constituting a signal line.

The metal layer 410 can be placed on a planar surface that is different from the planar surface in which the plurality of metal plates are placed and electrically separated from the plurality of metal plates. In other words, the metal layer 410 can form a layer that is different from the plurality of metal plates 430-1 and 430-2 in terms of electrical signals in the printed circuit board. For example, if the metal layer 410 is the power layer, the metal plates can be electrically connected to the ground layer. If the metal layer 410 is the ground layer, the metal plates can be electrically connected to the power layer. Alternatively, if the metal layer 410 is the signal layer, the metal plates can be electrically connected to the ground layer. If the metal layer 410 is the ground layer, the metal plates can be electrically connected to the signal layer.

The plurality of metal plates 430-1 and 430-2 can be placed on a planar surface above the metal layer 410. Any two metal plates can be electrically connected to each other through a stitching via. As such, each stitching via electrically connecting any two metal plates to each other can electrically connect every metal plate as one circuit.

Here, FIG. 4A shows a form (i.e. the form of FIG. 5A) in which a metal plate and its adjacent metal plates can be electrically connected to each other through one stitching via, and as a result, every metal plate can be electrically connected to each other. However, as long all metal plates can be formed as a closed loop by being electrically connected to one another, it can be possible to use any method of connecting the metal plates to one another through the stitching via.

Also, even though FIG. 4A shows each of metal plates having a square shape of the same size for the convenience of illustration, various other modifications can be possible (the same can be applied to the electromagnetic bandgap structure of the present invention). This will be briefly described with reference to FIG. 5A through FIG. 5E.

For example, the metal plates can have various polygonal shapes including not only a rectangle as shown in FIG. 5A and a triangle as shown in FIG. 5B, but also a hexagon, an octagon, etc. Of course, the metal plate may not be limited to a certain shape such as a circle or an ellipse. While each of the metal plates can also have the same size (e.g. area and thickness) as shown in FIG. 5A, FIG. 5B and FIG. 5E, it is possible that the metal plates have different sizes and can be distinguished and placed according to each of a plurality of groups having different sizes, as shown in FIG. 5C or FIG. 5D.

In the case of FIG. 5C, relatively larger metal plates B and relatively smaller metal plates C are alternately arranged. In the case of FIG. 5D, relatively larger metal plates D and relatively smaller metal plates E1, E2, E3 and E4 are arranged. The smaller metal plates E1, E2, E3 and E4 can be grouped in a 2×2 formation, and can occupy an area that is similar to that of the larger metal plate D.

In addition, while the cells of the electromagnetic bandgap structures can fill the entire inner surface of the printed circuit board as shown in FIG. 5A through 5D, the cells can be arranged on some paths as shown in FIG. 5E. For example, as shown in FIG. 5E, if it is assumed that a point represented by 11 refers to a noise source point and a point represented by 12 refers to a noise blocking destination point, the cells can be repeatedly arranged in at least one line along a noise transferable path between the noise source point 11 and the noise blocking destination point 12. Alternatively, as shown in FIG. 5E, if it is assumed that a point represented by 21 refers to the noise source point and a point represented by 22 refers to the noise blocking destination point, the cells can be arranged in at least one line to have the shape crossing and blocking a noise transferable path between the noise source point 21 and the noise blocking destination point 22 (i.e. the shape of being shielded by a blocking shield).

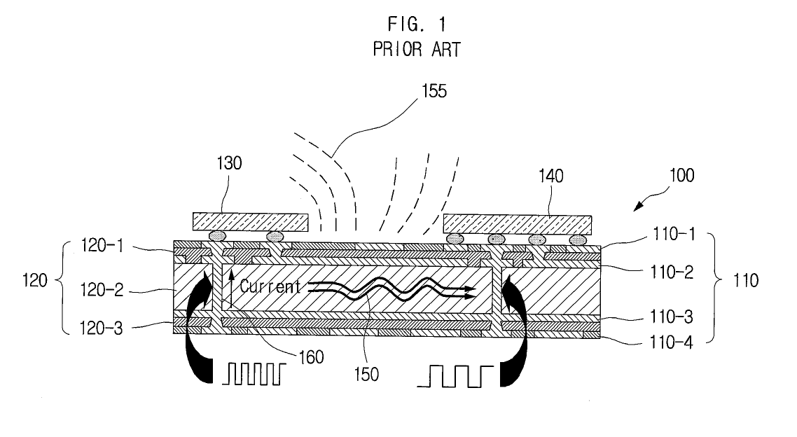

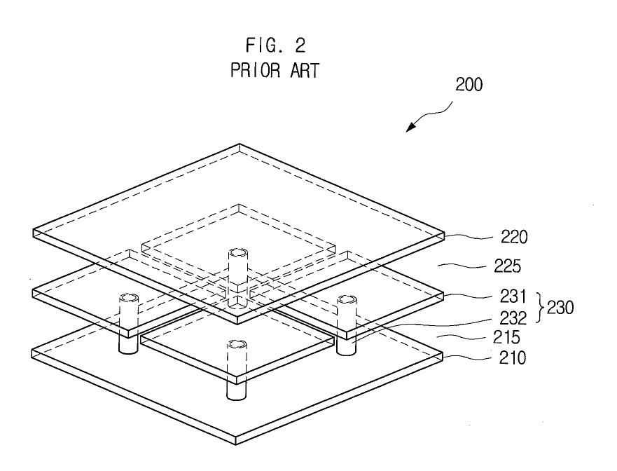

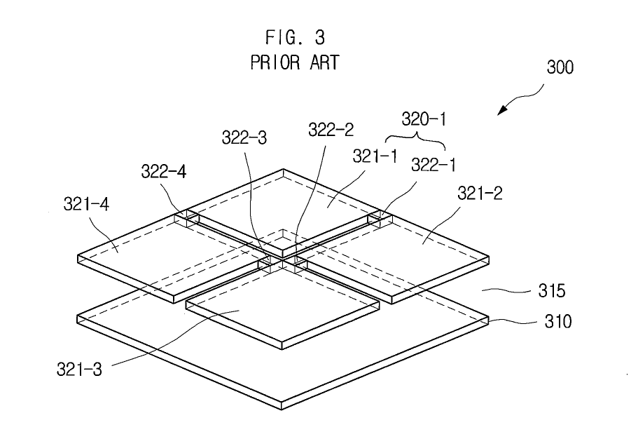

Here, if it is assumed that any two electronic circuits having different operation frequencies (refer to the first electric circuit 130 and the second electric circuit 140 in FIG. 1, described above) are implemented in the printed circuit board, the noise resource point and the noise blocking destination point can correspond to each respective position in which the two electric circuits will be implemented.

A stitching via can electrically connect any two metal plates of a plurality of metal plates to each other. All accompanying drawings of this specification show that the stitching via electrically connects two adjacent metal plates to each other. However, it may be unnecessary that any two metal plates connected by the stitching via are adjacent to each other. Also, even though it is shown that one metal plate is connected to another metal plate by one stitching via, it is evidently unnecessary that the electromagnetic bandgap structure has any limitation to the number of the stitching vias connecting any two metal plates. However, all below descriptions focus on the case of connecting two adjacent metal plates through one stitching via.

The stitching via 440 can be formed to include a first via 441, a second via 442 and a connection pattern 443 in order to electrically connect two adjacent metal plates.

For this electrical connection, the first via 441 can be formed to start from one end part 441a connected to the first metal plate 430-1 and penetrate the dielectric layer 420, and the second via 442 can be formed to start from one end part 442a connected to the second metal plate 430-2 and penetrate the dielectric layer 420. The connection pattern 443 can be placed on the same planar surface as the metal layer 410 and have one end part connected to the other end part 441b of the first via 441 and the other end part connected to the other end part 442b of the second via 442. Here, it is evident that a via land having a larger size than the via can be formed at one end part and the other end part of each via in order to reduce a position error of a drilling process for forming the via. Accordingly, the pertinent detailed description will be omitted.

Here, a clearance hole 450 can be formed at an edge of the connection pattern 443 of the stitching via 440 in order to prevent the metal plates 430-1 and 430-2 from being electrically connected to the metal layer 410.

The two adjacent metals 430-1 and 430-2 may not be connected on the same planar surface in the electromagnetic bandgap structure of FIG. 4A. Instead, the two adjacent metals 430-1 and 430-2 can be connected to each other through another planar surface (i.e. the same planar surface as the metal layer 410) through the stitching via 440. Accordingly, the electromagnetic bandgap structure 400 having the stitching via 440 of FIG. 4A can more easily acquire an inductance component with a longer length than the adjacent metal plates are connected to each other on the same planar surface under the same conditions. In addition, since the adjacent metal plates of the present invention are connected to each other through the stitching via 440, it is unnecessary to form an additional pattern for electrically connecting the metal plates placed on a second layer. This can make a spaced distance between the metal plates narrower. Accordingly, it can be possible to increase the capacitance component formed between the adjacent metal plates.

Described below is the principle by which the structure shown in FIG. 4A can function as an electromagnetic bandgap structure blocking a signal of a certain frequency band. The dielectric layer 420 is interposed between the metal layer 410 and the metal plates 430-1 and 430-2. This causes a capacitance component to be formed between the metal layer 410 and the metal plates 430-1 and 430-2 and between the two adjacent metal plates. Also, there forms an inductance component passing through the first via 441→the connection pattern 443→the second via 442 between the two adjacent metal plates by the stitching via 440. At this time, the value of the capacitance component can vary according to various factors such as the spaced distances between the metal layer 410 and the metal plates 430-1 and 430-2 and between the two adjacent metal plates, the dielectric constant of a dielectric material forming the dielectric layer 420 and the size, shape and area of the metal plate. Also, the value of the inductance component can vary according to various factors such as the shape, length, depth, width and area of the first via 441, a second via 442 and the connection pattern 443. Accordingly, adjusting and designing various aforementioned factors adequately can make it possible to allow the structure of FIG. 4A to function as an electromagnetic bandgap structure (i.e. a kind of a band stop filter) for removing or blocking a certain noise or a certain signal of an object frequency band. This can be easily understood through the equivalent circuit of FIG. 4B.

Comparing the equivalent circuit of FIG. 4B with the electromagnetic bandgap structure of FIG. 4A, an inductance component L1 can correspond to the first via 441, and an inductance component L2 can correspond to the second via 442. An inductance component L3 can correspond to the connection pattern 443. C1 can be a capacitance component by the metal plates 430-1 and 430-2 and another dielectric layer and another metal layer to be placed above the metal plates 430-1 and 430-2. C2 and C3 can be capacitance components by the metal layer 410 placed on the same planar surface as the connection pattern 443 and another dielectric layer and another metal layer to be placed below the planar surface of the connection pattern 443.

The electromagnetic bandgap structure shown in FIG. 4A can function as a band stop filter, which blocks a signal of a certain frequency band according to the above equivalent circuit. In other words, as seen in the equivalent circuit of FIG. 4B, a signal x of a low frequency band (refer to FIG. 4B) and a signal y of a high frequency band (refer to FIG. 4B) can pass through the electromagnetic bandgap structure, and signals z1, z2 and z3 of a certain frequency band (refer to FIG. 4B) ranging between the low frequency band and the high frequency band are blocked by the electromagnetic bandgap structure.

Accordingly, if the structure of FIG. 4A is repeatedly arranged on a whole part (refer to FIG. 5A. FIG. 5B, FIG. 5C and FIG. 5D) or a part (refer to FIG. 5E) of an inner surface of the printed circuit board (the same can be applied to the electromagnetic bandgap structure in accordance with an embodiment of the present invention described below) as a noise transferable path, it is possible to function as an electromagnetic bandgap structure that can prevent a signal of a certain frequency band from being transferred.

The identical or similar idea can be applied to the electromagnetic bandgap structure of FIG. 4C.

The electromagnetic bandgap structure of FIG. 4C has no metal layer corresponding to the reference numeral 410, as compared with the electromagnetic bandgap structure of FIG. 4A.

If there is a metal layer on the same planar surface that corresponds to an area on which the connection pattern 443 will be formed, the connection pattern 443 can be manufactured in the form of being accommodated in a clearance hole 450 formed in the metal layer 410 on the same planar surface, as shown in FIG. 4A. However, no additional metal layer may be placed in the area in which the connection pattern 443 will be formed, as shown in FIG. 4C. Of course, there may be a dielectric layer 420 below the metal plates in FIG. 4C.

Although not shown in the accompanying drawings, it may not be always necessary that the 2-layered electromagnetic bandgap structure including the stitching via is formed to have a stacked structural form in which the metal plates 430-1 and 430-2 are stacked over the dielectric layer 420 and the dielectric layer 420 is stacked over the metal layer 410. The 2-layered electromagnetic bandgap structure including the stitching via can be formed to have another structural shape in which a lower layer is the metal plates, and an upper layer is the metal layer, and the stitching via passes through the dielectric layer, which is interposed between the lower layer and the upper layer (i.e. a structural form with the position of the upper layer and the lower layer inversed from that of FIG. 4A).

Of course, this case can be expected to have the identical or similar noise blocking effect described above.

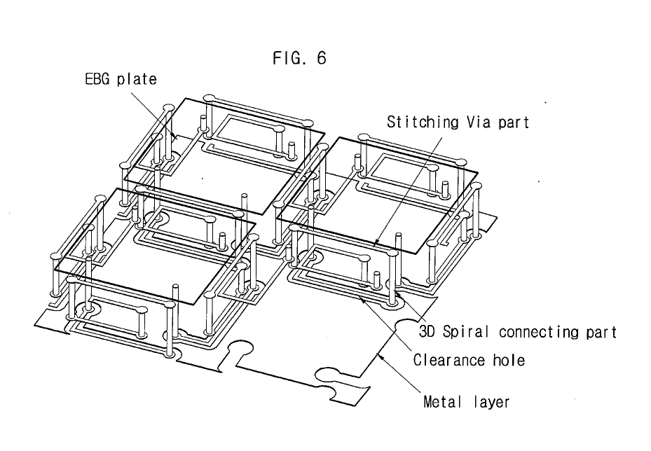

Hereinafter, an electromagnetic bandgap structure and a printed circuit board including the electromagnetic bandgap structure in accordance with an embodiment of the present invention will be described in detail with reference to FIG. 6 through FIG. 12. Below descriptions focus on the difference from the aforementioned electromagnetic bandgap structure, and any redundant or equally-applicable description of FIG. 4A through FIG. 5E (for example, the arrangement method of the metal plates, the arrangement position, the connection method, and the detail of the stitching via) will be omitted.

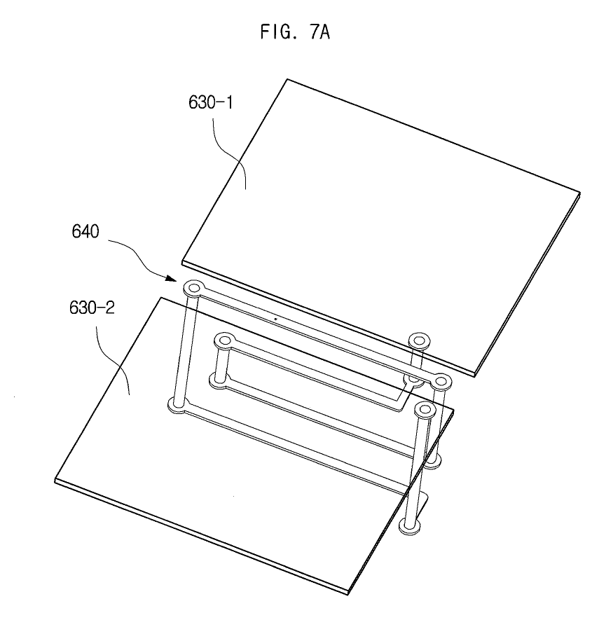

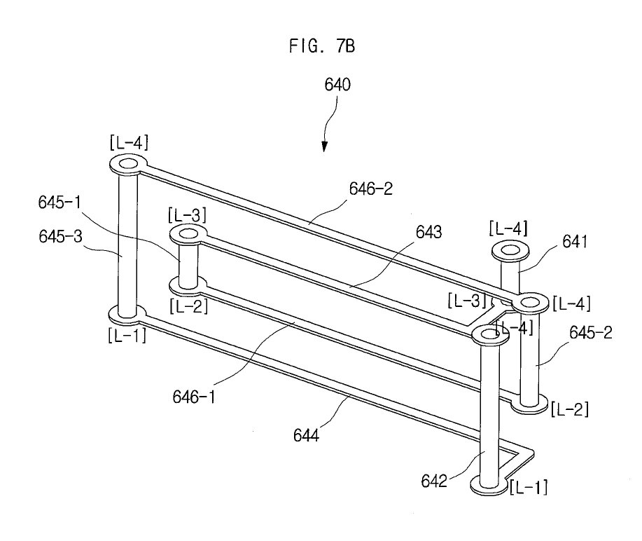

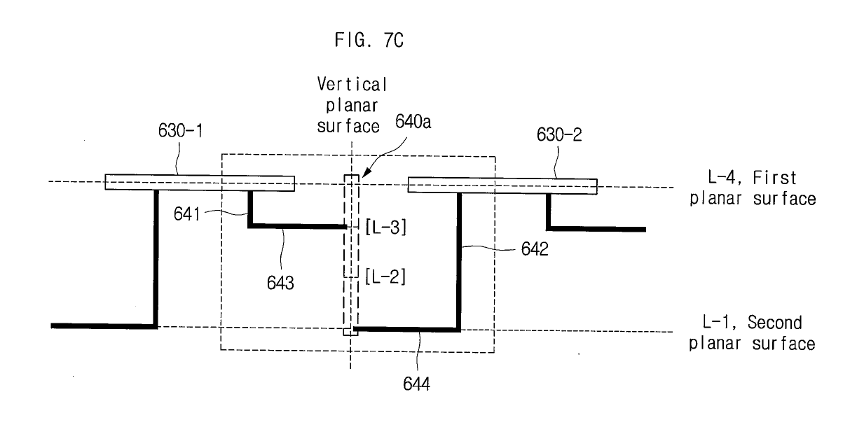

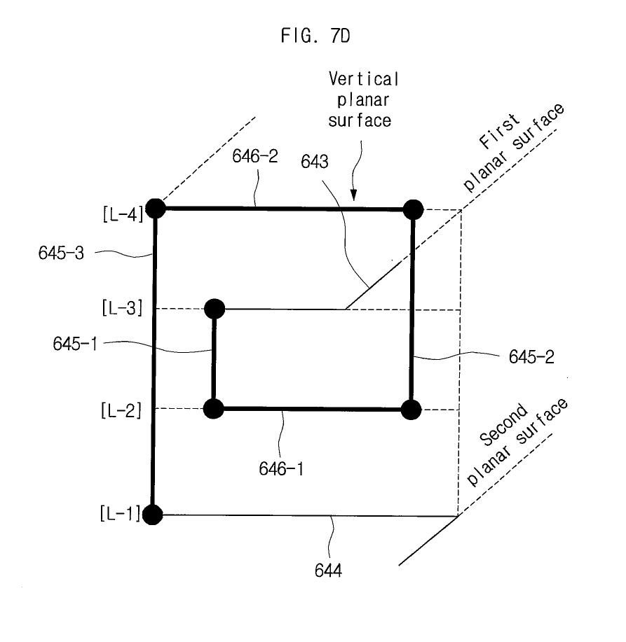

FIG. 6 is a 3D perspective view showing an electromagnetic bandgap structure in accordance with an embodiment of the present invention, and FIGS. 7A through 7D are detailed diagrams showing the electromagnetic bandgap structure shown in FIG. 6.

Illustrated in FIG. 6 is an electromagnetic bandgap structure that includes a plurality of metal plates (refer to the EBG plates shown in FIG. 6) and a stitching via part that electrically connects any two metal plates of the plurality of metal plates to each other.

Here, the plurality of metal plates are arranged on a particular planar surface (refer to a first planar surface shown in FIGS. 7C and 7D) of the printed circuit board, and the stitching via part electrically connects any two metal plates of the plurality of metal plates to each other through a planar surface that is a planar surface on which the metal layer of FIG. 6 is placed (refer to a second planar surface shown in FIGS. 7C and 7D) and is different from the first planar surface. In this case, if the metal layer, which needs to be electrically separated from the plurality of metal plates, exists in a place that faces the part where the plurality of metal plates are arranged, a clearance hole can be formed in a portion of the metal layer that corresponds to a path through which the stitching via part passes, as shown in FIG. 6. The above description is the same as the description for the previously description with reference to FIGS. 4A through 4C.

Compared to the electromagnetic bandgap structure shown in FIGS. 4a through 4C, however, the electromagnetic bandgap structure of the present embodiment has the following differences. These differences are caused by the difference in manufacturing the “stitching via part” to be used to implement the electromagnetic bandgap structure.

Below, with reference to FIGS. 7A through 7D, the characteristic structure of the stitching via part in accordance with an embodiment of the present invention will be described with a particular stitching via part 640 (shown in FIG. 7A) that connects any two metal plates (refer to the reference numerals 630-1 and 630-2 shown in FIG. 7A) of the plurality of metal plates to each other.

For the convenience of description, FIG. 7A only illustrates any two metal plates of the EBG cells (i.e., the plurality of metal plates) shown in FIG. 6. FIG. 7B separately illustrates the stitching via part 640 shown in FIG. 7A, and FIG. 7C is a vertical cross-sectional view of FIG. 7A.

As described above, any two metal plates of the plurality of metal plates, which are arranged on the first planar surface, can be electrically connected to each other through, for example, a single stitching via part, and the stitching via part 640 can be manufactured like the one shown in FIG. 7B in accordance with an embodiment of the present invention. The characteristic structure of the stitching via part 640 shown in FIG. 7B will be appreciated when FIGS. 7C and 7D are also referred.

With reference to FIGS. 7B through 7D, the stitching via part 640 shown in FIGS. 7B through 7D includes a first via 641, one end part of which is connected to one (refer to the first metal plate 630-1 shown in FIG. 7A) of the two metal plates 630-1 and 630-2, a second via 642, one end part of which is connected to the other (refer to the second metal plate 630-2 shown in FIG. 7A) of the two metal plates 630-1 and 630-2, a spiral connector 640a, which is formed on a vertical planar surface that is perpendicular to the first planar surface on which the metal plates 630-1 and 630-2 are located, a first conductive connecting pattern 643, which connects one end part of the spiral connector 640a and the other end part of the first via 641 with each other, and a second conductive connecting pattern 644, which connects the other end part of the spiral connector 640a and the other end part of the second via 642 with each other.

Here, the spiral connector 640a forms a spirally-shaped serial link structure (refer to FIG. 7D) on the vertical planar surface. One end part of the spirally-shaped link structure is connected to the first via 641 through the first conductive connecting pattern 643, and the other end part of the spirally-shaped link structure is connected to the second via 642 through the second conductive connecting pattern 644. Accordingly, the electromagnetic bandgap structure in accordance with an embodiment of the present invention can have a serial connection path through the first metal plate 630-1→the first via 641→the first conductive connecting pattern 643→the spiral connector 640a forming a spirally-shaped link structure on the vertical planar surface the second conductive connecting pattern 644→the second via 642→the second metal plate 630-2.

Here, as shown in FIGS. 7B and 7D, the spiral connector 640a can include a plurality of vias 645-1, 645-2 and 645-3 and a plurality of conductive connecting patterns 646-1 and 646-2, which are formed on the vertical planar surface, in order to form the spirally-shaped serial link structure on the vertical planar surface, which is perpendicular to the first planar surface.

Specifically, in order to form the spirally-shaped serial link structure, the spiral connector 640a can use vias to implement electrical connection between two different planar surfaces having different depths (heights) on the vertical planar surface and use conductive connecting patterns to implement electrical connection between two different locations on a same planar surface that is located in a same depth on the vertical planar surface.

More specifically, on a same vertical planar surface shown in FIG. 7D, the via 645-3 connects a layer L-1 in a first depth to a layer L-4 in a fourth depth; the via 645-1 connects a layer L-2 in a second depth to a layer L-3 in a third depth; the via 645-2 connects the layer L-2 in the second depth to the layer L-4 in the fourth depth; the conductive connecting pattern 646-1 connects two different locations with each other on the layer L-2 in the second depth; and the conductive connecting pattern 646-2 connects two different locations with each other on the layer L-4 in the fourth depth.

In other words, the electromagnetic bandgap structure in accordance with an embodiment of the present invention can be manufactured by forming a spirally-shaped structure on a particular planar surface that is perpendicular to the first planar surface, on which the metal plates (refer to 630-1 and 630-2 shown in FIGS. 7A and 7C) are placed, through the use of the plurality of vias (refer to 645-1, 645-2 and 645-3 shown in FIGS. 7B and 7D) and the plurality of conductive connecting patterns (refer to 646-1 and 646-2 shown in FIGS. 7B and 7D), which are formed on the planar surface. Then, one end part of the spirally-shaped structure is connected to the first via 641 and the first conductive connecting pattern 643, and the other end part of the spirally-shaped structure is connected to the second via 642 and the second conductive connecting pattern 644.

Compared to the previously described electromagnetic bandgap structure shown in FIGS. 4A through 4C, the electromagnetic bandgap structure of the present embodiment can significantly increase the length of the stitching via part (corresponding to an inductance component) that connects any two metal plates to each other. Accordingly, with the same size of the cell, the stop band frequency can be lowered, and thus the property of noise level in a low frequency band can be improved.

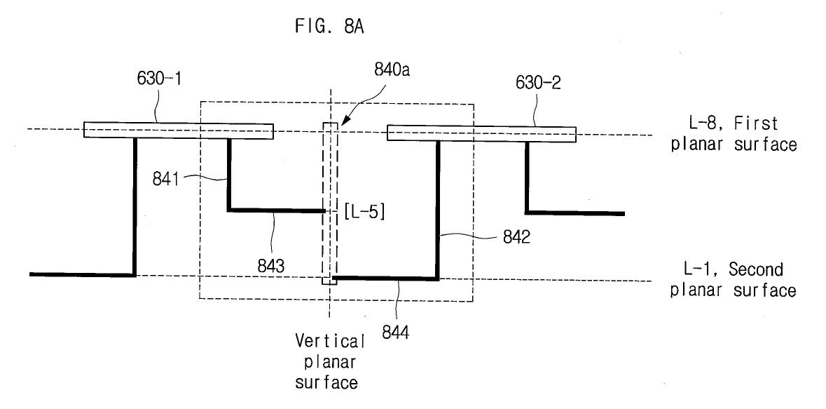

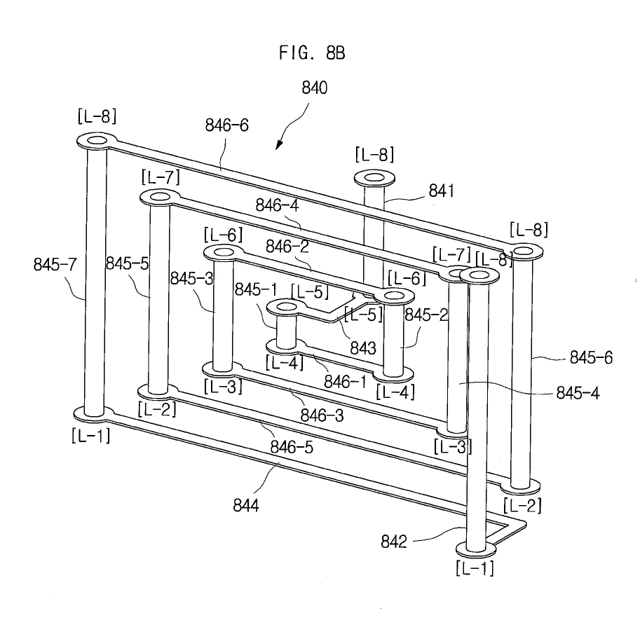

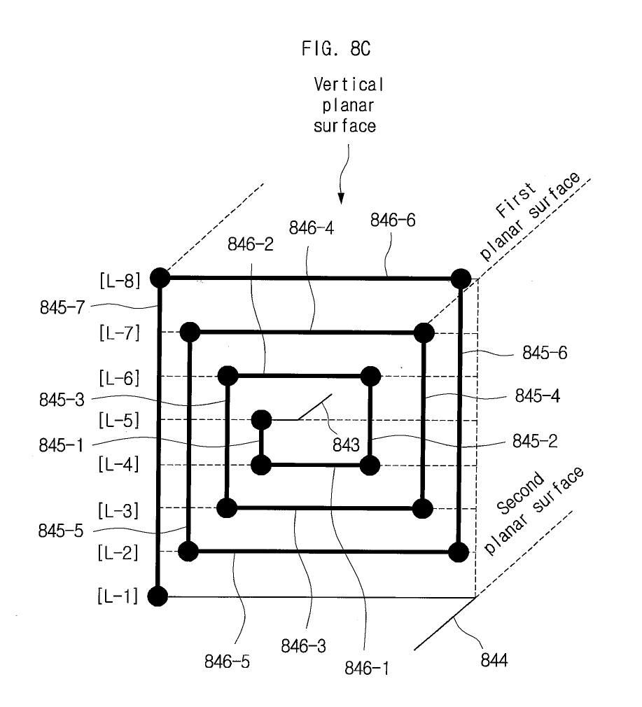

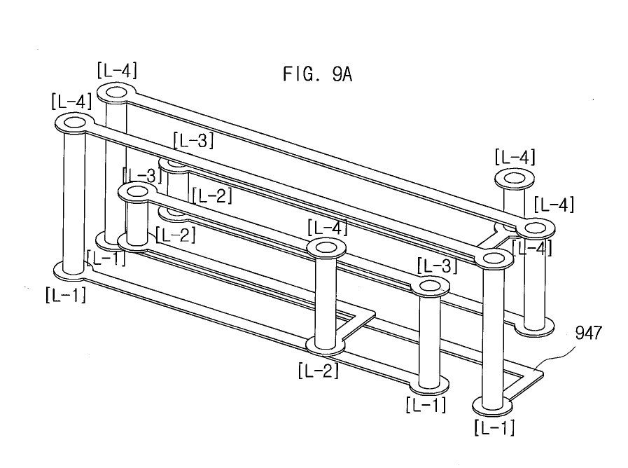

FIGS. 8A through 8C are diagrams showing an electromagnetic bandgap structure in accordance with another embodiment of the present invention.

While the previously described embodiment shown in FIGS. 7A through 7D provides an electromagnetic bandgap structure including the spiral connector 640a that has a 4-layered (i.e., L-1, L-2, L-3 and L-4) spiral structure on one vertical planar surface, the present embodiment shown in FIGS. 8A through 8C provides an electromagnetic bandgap structure including a spiral connector 840a that has an 8-layered (i.e., L-1 through L-8) spiral structure on one vertical planar surface.

With reference to FIGS. 8A through 8C, the first metal plate 630-a and the second metal plate 630-2 are electrically connected to each other through a stitching via part 840 that includes a first via 841, which is connected to the metal plate 630-1, a first conductive connecting pattern 843, which connects the first via 841 to one end part of a spiral connector 840a, the spiral connector 840a, which forms a spiral link structure on a vertical planar surface that is perpendicular to a first planar surface, a second via 842, which is connected to the second metal plate 630-2, and a second conductive connecting pattern 844, which connects the second via 842 to the other end part of the spiral connector 840a.

Here, as shown in FIGS. 8B and 8C, the spiral connector 840a includes a via 845-7, which connects a layer L-1 in a first depth to a layer L-8 in an eighth depth, a via 845-6, which connects a layer L-2 in a second depth to the layer L-8 in the eighth depth, a via 845-5, which connects the layer L-2 in the second depth to a layer L-7 in a seventh depth, a via 845-4, which connects a layer L-3 in a third depth to the layer L-7 in the seventh depth, a via 845-3, which connects the layer L-3 in the third depth to a layer L-6 in a sixth depth, a via 845-2, which connects a layer L-4 in a fourth depth to the layer L-6 in the sixth depth, and a via 845-1, which connects the layer L-4 in the fourth depth to a layer L-5 in a fifth depth, on a same vertical planar surface.

With reference to FIGS. 8B and 8C, the spiral connector 840a also includes a conductive connecting pattern 846-6, which connects two different locations with each other on the layer L-8 in the eighth depth, a conductive connecting pattern 846-4, which connects two different locations with each other on the layer L-7 in the seventh depth, a conductive connecting pattern 846-2, which connects two different locations with each other on the layer L-6 in the sixth depth, a conductive connecting pattern 846-1, which connects two different locations with each other on the layer L-4 in the fourth depth, a conductive connecting pattern 846-3, which connects two different locations with each other on the layer L-3 in the third depth, and a conductive connecting pattern 846-5, which connects two different locations with each other on the layer L-2 in the second depth, on the same vertical planar surface.

Likewise, as shown in FIGS. 8A through 8C, in forming the spiral connector 840a having a spirally-shaped serial link structure on an arbitrary vertical surface, the electromagnetic bandgap structure in accordance with another embodiment of the present invention can use vias to connect two different layers with each other on a corresponding vertical surface and use conductive connecting patterns to connect two different locations with each other on a same layer.

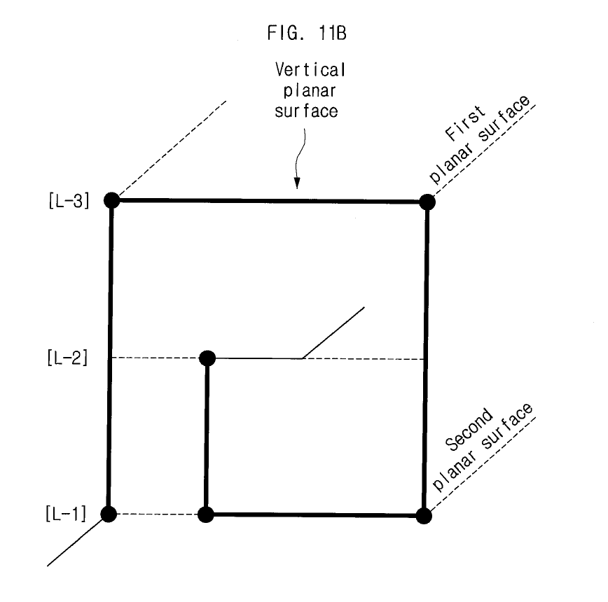

Although the previously described embodiments shown in FIGS. 7A through 8C describe the spiral connector having a 4- or 8-layered spiral link structure as examples, it is sufficient as long as the spiral link structure formed on a same planar surface can form a 2- or more layered spiral structure. For example, FIG. 11A illustrates a spiral connector having a 2-layered spiral structure formed on a same vertical planar surface, and FIG. 11B illustrates a spiral connector having a 3-layered spiral structure formed on a same vertical planar surface.

Although the embodiments shown in FIGS. 7A through 8C illustrate a spiral structure that emanates from a central point and bends and progresses to a farther away point, it is also possible that the spiral structure starts from an outside point toward the central point. Also, it is possible that the start point and end point of the spiral structure and its corresponding spiral path, etc. can vary according to the designer's choice (for example, the design conditions considering the frequency band to shield).

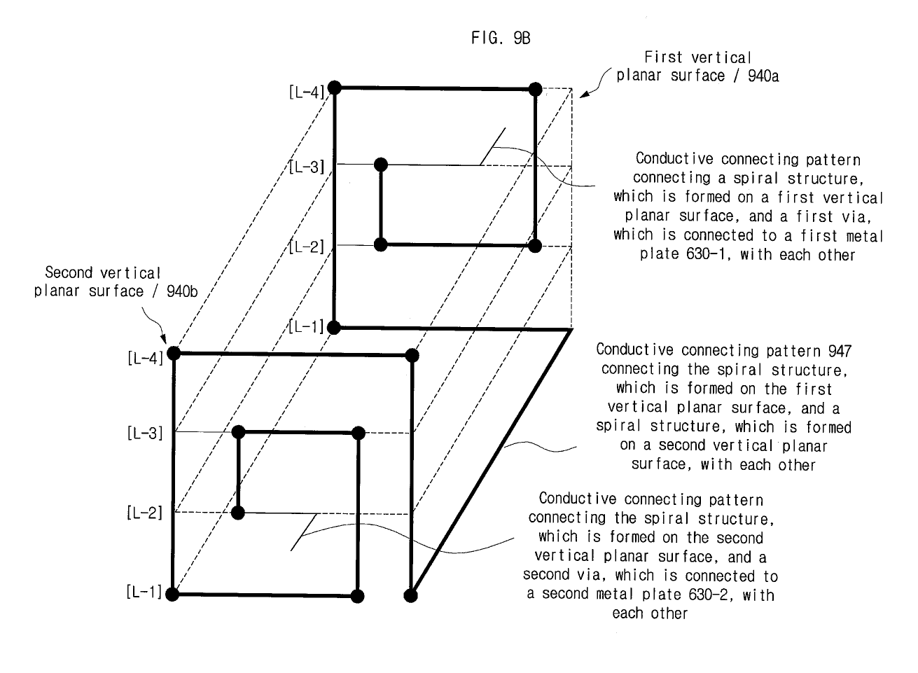

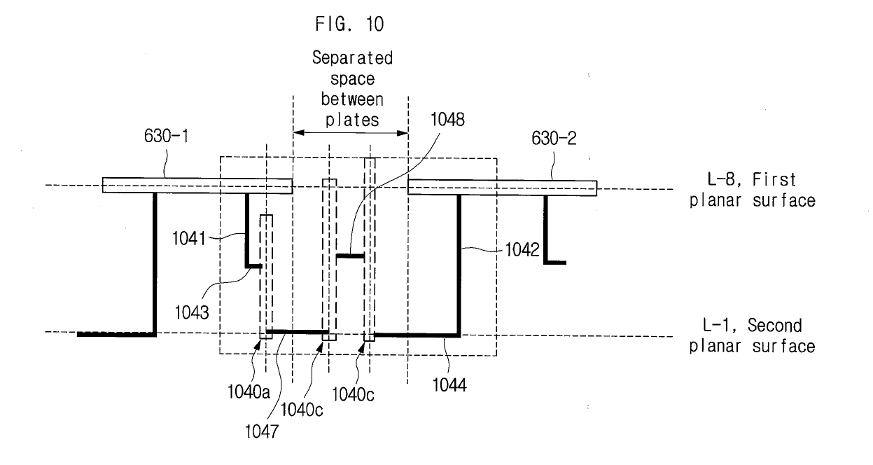

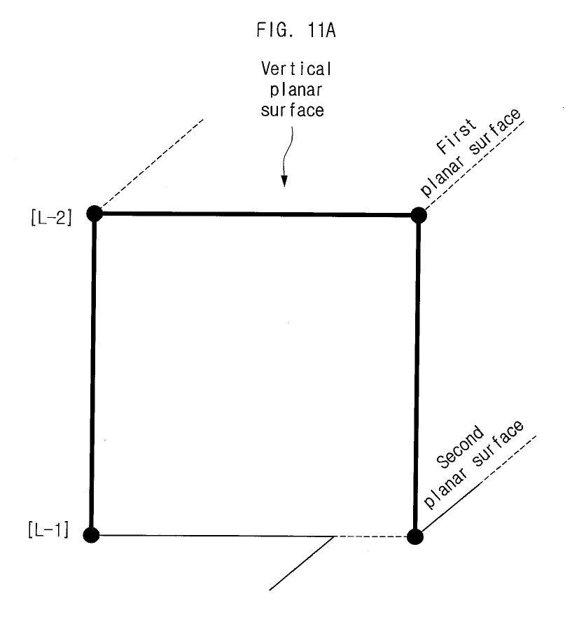

Hitherto, the previously described embodiments of the present invention have mainly described the spiral connector that is formed on any single vertical planar surface. Hereinafter, a case where the spiral connector is formed on two or more vertical planar surfaces will be described with reference to FIGS. 9A, 9B and 10.

FIGS. 9A through 9B are diagrams showing an electromagnetic bandgap structure in accordance with yet another embodiment of the present invention.

Illustrated in FIG. 9A is a stitching via part that includes “a spiral connector having a twofold spiral structure.” Specifically, in the case of FIG. 9A, two 4-layered spiral structures are overlapped (duplicated or repeated) with each other on two different vertical planar surfaces. This will become more apparent through FIG. 9B.

As shown in FIG. 9B, “the spiral connector having a twofold spiral structure” includes a first spiral structure (refer to the referential numeral 940a) formed on a first vertical planar surface that is perpendicular to the first planar surface on which metal plates are formed, and a second spiral structure (refer to the referential numeral 940b) formed on a second vertical planar surface that is formed at a different location from the first vertical planar surface. Here, the first spiral structure 940a and the second spiral structure 940b are connected to each other by a conductive connecting pattern 947, thereby forming a serial link structure.

Accordingly, “the spiral connector” constituting the stitching via part in the electromagnetic bandgap structure of the present invention can significantly increase the entire length, i.e., the inductance component, of the stitching via part, despite a narrower surface area of the printed circuit board, since the spiral structure is repeatedly formed on two or more different vertical planar surfaces.

Although the embodiment shown in FIGS. 9A and 9B illustrates a spiral connector of twofold spiral structure, the spiral connector can be formed with threefold or more spiral structure, as shown in FIG. 10.

With reference to FIG. 10, three spiral structures (refer to 1040a, 1040b and 1040c) constituting the spiral connector are respectively formed on three different vertical planar surfaces, which are perpendicular to a first planar surface L8, and the three spiral structures 1040a, 1040b and 1040c are connected to one another by using conductive connecting patterns 1047 and 1048. Also, the spiral connector is connected to the first metal plate 630-1 by having an end part of the spiral connector connected to a first conductive connecting pattern 1043 and a first via 1041 and is connected to the second metal plate 630-2 by having the other end part of the spiral connector connected to a second conductive connecting pattern 1044 and a second via 1042.

In the present invention, at least one vertical planar surface on which the spiral connector is to be formed can be a vertical planar surface (refer to the positions of 1040b and 1040c in the case of FIG. 10) that exists in a separated space (refer to “separated space between plates” shown in FIG. 10) between the two metal plates 630-1 and 630-2, which are connected to each other by the stitching via part.

However, it is not required to have the same configuration as described above. In other words, at least one vertical planar surface does not have to exist in the separated space between the metal plates 630-1 and 630-2 if the spiral structure constituting the spiral connector is formed on a vertical planar surface (refer to 1040a shown in FIG. 10) having a different (i.e., lower) depth from the depth of the metal plates 630-1 and 630-2 such that the vertical planar surface 1040a is not overlapped with the metal plates 630-1 and 630-2 (that is, there is no electrical connection formed between the vertical planar surface 1040a and the metal plates 630-1 and 630-2).

Furthermore, in the case of FIGS. 6 through 9B, the spiral structure formed by the spiral connector is formed on a vertical planar surface that exists between the first planar surface, on which the metal plates are placed, and the second planar surface, on which the metal layer is placed, but other various modifications can be possible. In one example, the spiral connector can be formed on a vertical planar surface that is extended to a planar surface over the first planar surface, on which the metal plates are placed (refer to 1040c shown in FIG. 10).

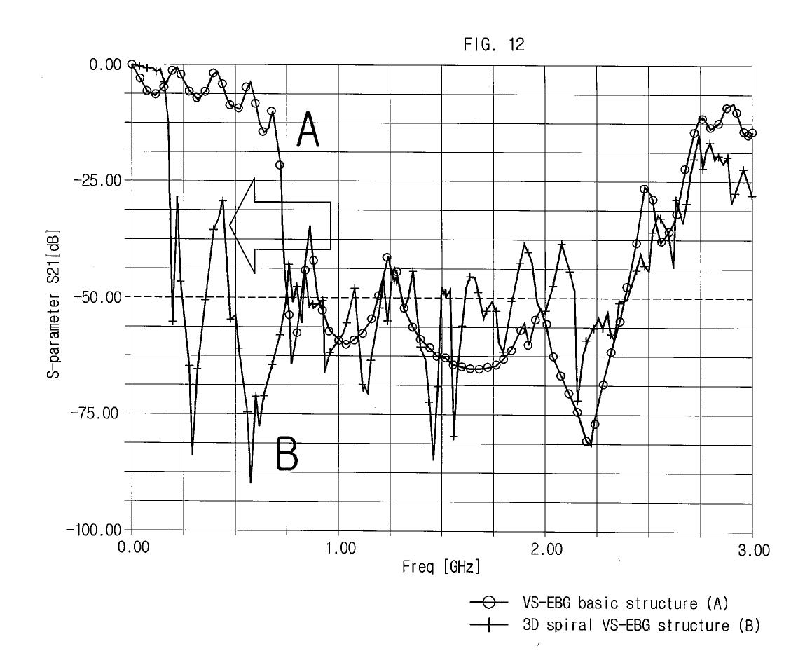

FIG. 12 is a graph showing a bandgap frequency property of an electromagnetic bandgap structure in accordance with an embodiment of the present invention. FIG. 12 shows a simulation result that is analyzed with a same EBG cell size and same design by scattering parameters in order to compare the stop band property between the basic VS-EBG structure A shown in FIGS. 4A through 4C and the spiral VS-EBG structure B including the spiral connector provided by the present invention.

With reference to FIG. 12, it can be seen that the spiral VS-EBG structure B including the spiral connector provided by the present invention has a lower stop band and bandgap, which is about 500 MHz lower, on a blocking rate −50 dB basis in a same cell size, compared to the basic VS-EBG structure A. Accordingly, as described above, the spiral VS-EBG structure provided by the present invention can have an improved noise level property in a low frequency band in the same cell size by the significantly increased impedance component obtained by the spiral connector.

By utilizing certain embodiments of the present invention as set forth above, the conductive noise problem can be solved by disposing a specially structured electromagnetic bandgap structure in a printed circuit board even though a bypass capacitor or a decoupling capacitor is not used. Furthermore, since the electromagnetic bandgap structure in accordance with certain embodiments of the present invention has the design flexibility and design freedom that is appropriate for a printed circuit board and allows various bandgap frequency bands to be implemented, it can be universally employed in various application products (for example, an electronic device such as a mobile communication terminal in which an RF circuit and a digital circuit are mounted on a same substrate, a System in Package (SiP) and a network board).

While the spirit of the invention has been described in detail with reference to certain embodiments, the embodiments are for illustrative purposes only and shall not limit the invention. It is to be appreciated that those skilled in the art can change or modify the embodiments without departing from the scope and spirit of the invention.

What is claimed is:

1. An electromagnetic bandgap structure comprising a plurality of conductive plates and a stitching via part, the plurality of conductive plates being placed on a first planar surface, the stitching via part electrically connecting any two conductive plates of the plurality of conductive plates with each other, wherein the stitching via part comprises:
a first via having one end part connected to one of the two conductive plates;
a second via having one end part connected to the other of the two conductive plates;
a spiral connector forming a spirally-shaped serial link structure on at least one vertical planar surface that is perpendicular to the first planar surface;
a first conductive pattern connecting one end part of the spiral connector and the other end part of the first via with each other; and
a second conductive connecting pattern connecting the other end part of the spiral connector and the other end part of the second via with each other.

2. The electromagnetic bandgap structure of claim 1, wherein the spiral connector forms the spirally-shaped serial link structure on the at least one vertical planar surface by using a conductive connecting pattern to connect two different locations with each other on a same planar surface and using a via to connect two different planar surfaces with each other.

3. The electromagnetic bandgap structure of claim 2, wherein the at least one vertical planar surface on which the spiral connector is to be formed is a vertical planar surface that exists in a position corresponding to a separated space between the two conductive plates, the two conductive plates being connected to each other by the stitching via part.

4. The electromagnetic bandgap structure of claim 2, wherein, if the spiral connector is formed on two or more vertical planar surfaces, two or more spiral link structures are formed on the two or more vertical planar surfaces, respectively, and parts placed on different vertical planar surfaces are connected to each other by a conductive connecting pattern so that the spirally-shaped serial link structure is formed.

5. The electromagnetic bandgap structure of claim 2, wherein the spiral connector forms the spirally-shaped serial link structure by manufacturing a link structure that is bent at least once by using the at least one conductive connecting pattern and the at least one via, the spirally-shaped serial link structure passing through a plurality of layers that exist on the at least one vertical planar surface, the at least one conductive connecting pattern connecting two different locations with each other on the same planar surface, the at least one via connecting two different planar surfaces with each other.

6. The electromagnetic bandgap structure of claim 1, wherein a dielectric layer is placed on an upper side or a lower side of the plurality of conductive plates, and the vias included in the stitching via part penetrate through the dielectric layer.

7. The electromagnetic bandgap structure of claim 1, wherein, if there is a conductive layer that faces the plurality of conductive plates and is placed on a second planar surface, a clearance hole is formed in a portion of the conductive layer that corresponds to a path through which the stitching via part passes such that the stitching via part and the conductive layer can be electrically separated from each other.

8. The electromagnetic bandgap structure of claim 1, wherein the conductive connecting patterns included in the stitching via part is manufactured as a straight-line form or a line form broken one or more times.

9. A printed circuit board in which an electromagnetic bandgap structure is disposed in an area of a noise transferable path between a noise source point and a noise blocking destination point of the printed circuit board, the electromagnetic bandgap structure including a plurality of conductive plates and a stitching via part, the plurality of conductive plates being placed on a first planar surface, the stitching via part electrically connecting any two conductive plates of the plurality of conductive plates with each other, wherein the stitching via part comprises:
a first via having one end part connected to one of the two conductive plates;
a second via having one end part connected to the other of the two conductive plates;
a spiral connector forming a spirally-shaped serial link structure on at least one vertical planar surface that is perpendicular to the first planar surface;
a first conductive pattern connecting one end part of the spiral connector and the other end part of the first via with each other; and
a second conductive connecting pattern connecting the other end part of the spiral connector and the other end part of the second via with each other.

10. The printed circuit board of claim 9, wherein the spiral connector forms the spirally-shaped serial link structure on the at least one vertical planar surface by using a conductive connecting pattern to connect two different locations with each other on a same planar surface and using a via to connect two different planar surfaces with each other.

11. The printed circuit board of claim 10, wherein the at least one vertical planar surface on which the spiral connector is to be formed is a vertical planar surface that exists in a position corresponding in a separated space between the two conductive plates, the two conductive plates being connected to each other by the stitching via part.

12. The printed circuit board of claim 10, wherein, if the spiral connector is formed on two or more vertical planar surfaces, two or more spiral link structures are formed on the two or more vertical planar surfaces, respectively, and parts placed on different vertical planar surfaces are connected to each other by a conductive connecting pattern so that the spirally-shaped serial link structure is formed.

13. The printed circuit board of claim 10, wherein the spiral connector forms the spirally-shaped serial link structure by manufacturing a link structure that is bent at least once by using the at least one conductive connecting pattern and the at least one via, the spirally-shaped serial link structure passing through a plurality of layers that exist on the at least one vertical planar surface, the at least one conductive connecting pattern connecting two different locations with each other on the same planar surface, the at least one via connecting two different planar surfaces with each other.

14. The printed circuit board of claim 9, wherein a dielectric layer is placed on an upper side or a lower side of the plurality of conductive plates, and the vias included in the stitching via part penetrate through the dielectric layer.

15. The electromagnetic bandgap structure of claim 9, wherein, if there is a conductive layer that faces the plurality of conductive plates and is placed on a second planar surface, a clearance hole is formed in a portion of the conductive layer that corresponds to a path through which the stitching via part passes such that the stitching via part and the conductive layer can be electrically separated from each other.

16. The printed circuit board of claim 15, wherein the conductive plates are electrically connected to one of a ground layer and a power layer, and the conductive layer is electrically connected to the other of the ground layer and the power layer.

17. The printed circuit board of claim 15, wherein the conductive plates are electrically connected to one of a ground layer and a signal layer, and the conductive layer is electrically connected to the other of the ground layer and the signal layer.

18. The printed circuit board of claim 9, wherein, if two electronic circuits having different operation frequencies are installed in the printed circuit board, the noise source point and the noise blocking destination point correspond to one position and the other position, respectively, in which the two electric circuits are to be installed.
